(19) United States
(12) Patent Application Publication
(10) Pub. No.: US 2013/0263963 A1
(43) Pub. Date: Oct. 10, 2013

(54) REINFORCEMENT STACK

(71) Applicants: Mark Douglas Kalman, Luthersville, GA (US); John R. Belcher, Panama City, FL (US)

(72) Inventors: Mark Douglas Kalman, Luthersville, GA (US); John R. Belcher, Panama City, FL (US)

(73) Assignee: DEEPFLEX INC., Houston, TX (US)

(21) Appl. No.: 13/876,448

(22) PCT Filed: Sep. 30, 2010
(86) PCT No.: PCT/US10/50802

§ 371 Date: Jun. 5, 2013

(51) Int. Cl. F16L 11/10; B29D 23/00

(52) U.S. Cl. CPC F16L 11/10; B29D 23/001
USPC 138/153; 156/244.11; 156/196

(57) ABSTRACT

In one aspect, the present disclosure relates to an armor layer of an unbonded flexible pipe. The armor layer includes a stack of reinforcement tapes wherein at least one of a top reinforcement tape and a bottom reinforcement tape of the stack comprises a resin rich surface. In another aspect, the present disclosure relates to an armor layer of an unbonded flexible pipe. The armor layer includes a stack of reinforcement tapes wherein at least one of a top reinforcement tape and a bottom reinforcement tape in the stack comprises a radiused corner wherein the radiusing of the corner begins at a position along the vertical height of the reinforcement tape no more than one half the height of the reinforcement tape.

### BACKGROUND OF THE DISCLOSURE

1. Field of the Disclosure

The present disclosure relates to laminated assemblies of fiber reinforced polymer composite reinforcement strips, hereinafter referred to as stacks. Specifically, this disclosure relates to modified tape layers of the reinforcement stacks.

2. Description of the Related Art

Flexible fiber-reinforced pipe is an unbonded flexible pipe used in natural resource deposit extraction. Unbonded flexible fiber-reinforced pipes may be made with reinforcement stacks composed of fiber-reinforced polymer composite tape and applied to form an armor layer for the flexible pipe. Inter-laminar adhesive may be applied to surfaces of the tapes to allow for bonding between the tapes to form a reinforcement stack. After application of the adhesive, the reinforcement stack may be helically wrapped on a pipe and cured, thereby allowing the inter-laminar adhesive to bond and strengthen the reinforcement stack.

### SUMMARY OF THE CLAIMED SUBJECT MATTER

In one aspect, the present disclosure relates to an armor layer of an unbonded flexible pipe. The armor layer includes a stack of reinforcement tapes wherein at least one of a top reinforcement tape and a bottom reinforcement tape of the stack comprises a resin rich surface.

In another aspect, the present disclosure relates to an armor layer of an unbonded flexible pipe. The armor layer includes a stack of reinforcement tapes wherein at least one of a top reinforcement tape and a bottom reinforcement tape in the stack comprises a corner radius greater than one-half the thickness of the at least one of the top reinforcement tape and the bottom reinforcement tape.

In another aspect, the present disclosure relates to a method to manufacture an armor layer of an unbonded flexible pipe. The method includes forming a plurality of reinforcement tapes through pultrusion, forming a first modified reinforcement tape having a resin-rich surface through co-pultrusion, and forming the armor layer by stacking the plurality of reinforcement tapes and the first modified reinforcement tape with the first modified reinforcement tape disposed on one of a top surface and a bottom surface of the armor layer.

In another aspect, the present disclosure relates to a method to manufacture an armor layer of an unbonded flexible pipe. The method includes forming a plurality of reinforcement tapes through pultrusion, forming a first modified reinforcement tape having a corner radius greater than one-half the thickness of the first modified reinforcement tape, and forming the armor layer by stacking the plurality of reinforcement tapes and the first modified reinforcement tape with the first modified reinforcement tape disposed on one of or both of a top surface and a bottom surface of the armor layer.

### BRIEF DESCRIPTION OF DRAWINGS

Features of the present disclosure will become more apparent from the following description in conjunction with the accompanying drawings.

FIG. 1 shows an isometric view of a composite flexible pipe.

FIGS. 2A-2C show cross-sectional views of reinforcement stacks in accordance with one or more embodiments of the present disclosure.

FIGS. 3A and 3B show cross-sectional views of reinforcement stacks in accordance with one or more embodiments of the present disclosure.

FIGS. 4A and 4B show cross-section views of reinforcement stacks on a flexible pipe in accordance with one or more embodiments of the present disclosure.

### DETAILED DESCRIPTION

The present disclosure provides modified reinforcement stacks for unbonded composite flexible pipe. Embodiments disclosed herein may provide modified reinforcement stacks to composite pipe structures as disclosed in U.S. Pat. No. 6,491,779, issued on Dec. 12, 2002, entitled “Method of Forming a Composite Tubular Assembly,” U.S. Pat. No. 6,804,942, issued on Oct. 19, 2004, entitled “Composite Tubular Assembly and Method of Forming Same,” and U.S. Pat. No. 7,254,933, issued on Aug. 14, 2007, entitled “Anti-collapse System and Method of Manufacture,” all of which are hereby incorporated by reference in their entireties.

To form certain structural layers (armor layers, e.g. tensile and/or hoop) of an unbonded flexible fiber-reinforced pipe, reinforcement stacks may be helically wound to provide reinforcement, support, structure, strength, and/or protection. The reinforcement stacks may be formed from tape layers coated with a bonding material, and the bonding material may require curing to bond the tape layers to achieve appropriate operational properties. For example, the reinforcement stacks may (desirably) be chemically resistant, thermally insulating, strong enough to provide support, flexible enough to provide relative movement and/or sliding, flexible enough to allow the pipe to bend, and/or may be configured to any other necessary and/or desired operational properties. A plurality of reinforcement stacks may be helically wound to form a layer in an unbonded flexible pipe. The layer comprising the plurality of reinforcement stacks may be used to perform the function of the pressure armor or tensile armor, which are defined in ISO 13628-2/API 17J, incorporated herein by reference.

The tape layers that may form the reinforcement stacks may be fiber reinforced tapes. Specifically, the tapes may comprise composite matrix materials and/or polymers, as discussed below. The composite matrix materials and/or polymers that compose the tape layers may be partially or fully cured when the tape is prepared to form a reinforcement stack. Further, the tape layers may be reinforced with fibers that may be unidirectional. The fibers may be made of materials such as aramids, para-aramids, basalt, aromatics, ceramics, polyester, polyolefin, carbon fiber, graphite fiber, fiberglass, E-glass, chemical resistant E-glass, S-glass, metallic fibers, and/or any other fibrous material and/or any combinations thereof Manufacturing of the tape layers with unidirectional fibers may be done through pultrusion.

The tape layers may be gathered to form reinforcement stacks at the same time as installation of the reinforcement stacks onto the surface of the pipe. Accordingly, application of a bonding material, such as an inter-laminar adhesive, may be applied during the formation and installation processes of reinforcement stacks in accordance with one or more embodiments disclosed herein. Alternatively, the inter-laminar adhesive may be applied to the surfaces of the tape layers prior to the formation and installation process of the reinforcement stacks, such as during the tape manufacturing process, or an intermediate process between tape manufacture and reinforcement stack formation. Alternatively, the reinforcement stacks may be formed by an independent manufacturing process prior to the manufacturing process of the flexible pipe.

According to one or more embodiments of the present disclosure, the reinforcement stacks may be formed by placing films of adhesive (similar to a tape) between each layer of tape that may be collected (or stacked) to form the reinforcement stack. Alternatively, a film of adhesive may be calendered onto one or more surfaces of the tape layers, for example by rolling application and/or running the film and tape layers between rollers to compress the adhesive onto the surface of the tape layer. Alternatively still, a liquid adhesive may be sprayed and/or dispensed to form a layer of adhesive on one or more surfaces of the tape layers. Moreover, a powder adhesive may be applied to one or more surfaces of the tape layers, for example, by electrostatic application. Further, those skilled in the art will appreciate that other methods and/or processes or combinations thereof of application of the adhesive to one or more surfaces of the tape layers may be used without deviating from the scope of the present disclosure. Curing of the adhesive may be performed as disclosed in U.S. Provisional Patent Application No. 61/324,223, filed on Apr. 14, 2010, entitled “Radiation Cured Reinforcement Stacks,” which is hereby incorporated by reference in its entirety.

The adhesive may include polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, polyether, epoxy resin, polyurethane, and/or polyoxymethylene and/or other adhesives known in the art and/or combinations thereof. Further, for example, an adhesive may be provided in a film, fluid, solid, gel, and/or powder state, thereby allowing for any particular type of application that may be necessary and/or available during manufacturing of the reinforcement stacks. Accordingly, the adhesive may be partially cured or completely uncured at the time of application to the tape layers.

In accordance with one or more embodiments of the present disclosure, at least one of the tape layers that is used to form the reinforcement stack may be a modified tape layer, and may be located at the top or bottom of the stack to which the modified tape layer may be applied. The remaining unmodified tape layers may form a body of the reinforcement stack. Modification may include radiusing the corners of the tape layer, adding a resin rich and/or other material surface (e.g., anti-wear material) to the tape layer, providing additional thickness to the layer, and/or combinations thereof. The additional surface and/or modification of the modified tape layer may provide an external surface and/or protective layer to the reinforcement stack.

A modified tape layer with a radiused corner may allow for efficient manufacturing of composite flexible pipe. In particular, the radiused corners may allow for a reduction in reinforcement stack damage during manufacture due to fewer sharp corners on the tape stacks. Accordingly, an efficient assembly process may be provided for by application of a radiused corner on the tape stacks. As used herein radiused and/or radiusing means a curved or rounded surface that may have a constant or varying radius such that no sharp corners are present. Radiusing the corner, as used herein, means to round or smooth the corner, and encompasses circular, elliptical, and varying curvatures. Accordingly, a radiused corner may vary in radius along the transition from a horizontal surface to a vertical surface.

In accordance with one or more embodiments disclosed herein, a radiused corner may have a curvature of the corner start at a position along a vertical height of the reinforcement tape no more than one half the height of the reinforcement tape. Accordingly, the radiusing (or curvature) may start at a position half-way along the vertical surface of the reinforcement tape and begin to curve towards the horizontal surface of the top (or bottom) of the reinforcement tape. Further, as the radiusing may not be of a uniform radius, the curvature may be elongated such that the radiused corner, in cross-section, forms a partial ellipse. Moreover, those skilled in the art will appreciate that the starting point of the radiused corner along the vertical of the reinforcement tape may start at any position along the vertical without departing from the scope of the present disclosure.

Moreover, a radiused corner may minimize stress concentrations at the corner of the reinforcement stack after installation on a flexible pipe. An anti-extrusion material may be layered above or below the reinforcement stacks in construction of the pipe to provide gap control between adjacent windings of the reinforcement stacks, thereby preventing blow-through of adjacent layers. The resistance to blow-through may be dependent on the radius of the reinforcement stack corner that is in contact with the anti-extrusion material. Accordingly, a reinforcement stack in accordance with one or more embodiments of the present disclosure may provide an increased corner radius of the reinforcement stack to minimize the stress concentration at the corner of the stack and may prevent the anti-extrusion material from tearing and/or shearing, thereby improving blow-through resistance.

Additionally, the reinforcement stack in accordance with one or more embodiments of the present disclosure may allow for improved dynamic service. In particular, the radiused corner may also reduce wear between a reinforcement stack and an anti-wear layer that may be applied above or below the reinforcement layers in construction of the flexible pipe.

A modified tape layer with a resin (or other material) rich surface may allow for a more wear resistant surface of the reinforcement stack. The resin rich surface may prevent fibers of the tape layers from protruding from the reinforcement stack. The resin rich surface may provide additional wear resistance to the tape layer without adding substantial thickness and/or weight to the pipe. The resin rich surface may be formed from composite matrix materials and/or polymers, including, but not limited to polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, epoxy resin, polyurethane, polyoxymethylene, polysulfone, polyethersulfone, polyphenyl-sulfone, polyetherimide, polytetrafluoroethylene, perfluoropolyether, molybdenum disulfide, polyimide, liquid crystal polymers, polyphthalamide, cationic clay silicate, polyamide, polyureas, polyesters, polyacetals, polyethers, polyoxides, polysulfides, polysulphones, polyacrylates, polyethylene terephthalate, polyether-ether-ketones, polyvinyls, and/or polyacrylonitrils, copolymers of the preceding, and/or fluorous polymers, and/or combinations thereof.

Thus, the resin rich surface may provide anti-wear properties, in addition to preventing fibers of the tape layers from being exposed at the surface of the reinforcement layer. As such, the resin rich surface may include anti-wear materials described in American Petroleum Institute Specifications 17J and 17B, U.S. Pat. No. 7,770,603, issued Aug. 10, 2010, entitled “Flexible Tubular Pipe with an Anti-Wear Sheath,” and U.S. Patent Application Publication Number 2010/0062202, filed Mar. 17, 2008, entitled “Flexible Pipe,” which are hereby incorporated in their entireties, thereby providing an anti-wear layer. Accordingly, an unbonded flexible pipe manufactured with reinforcement stacks in accordance with one or more embodiments disclosed herein may eliminate the need for separate anti-wear layers. Therefore, efficiency of construction of flexible pipe may be improved. The weight of the pipe may be reduced by eliminating the separate anti-wear layers. Further, the overall pipe diameter may be reduced. Moreover, fewer layers may need to be applied to the pipe, thereby reducing construction time.

Furthermore, because wear is a result of relative motion and contact pressure between two surfaces, the anti-wear layer may be included in construction of a flexible pipe. The anti-wear layer and the resin rich surface may be selected to prevent wear in high temperature and high pressure dynamic service.

Further, tensile armor layers, either metallic or non-metallic, or a reinforcement stack performing the function of a tensile armor wire, in an unbonded flexible pipe, may slip or displace relative to the adjacent layer when the pipe is bent. The bending radius at which the slip occurs is often called the slip onset radius. The slip onset radius is higher if the coefficient of friction between the tensile armor layer and the adjacent layer is lower. The stress due to bending in the tensile armor layer is lower with a higher slip onset radius. Thus, a lower coefficient of friction between the tensile armor layer and an adjacent layer is desirable to reduce bending stress in the tensile armor. Reduced bending stress may desirably reduce fatigue of the tensile armor in dynamic service. Thus, the resin rich surface material and surface finish and adjacent layer material and surface finish may be selected to minimize the friction coefficient between the tensile armor layer and the adjacent layer.

A modified tape layer with additional thickness may, similarly, prevent fibers of the tape layer from protruding from the surface of the reinforcement stack. The additional thickness may be composed of a resin or may be produced from similar materials as the matrix of the tape layers, as discussed above.

Modified tape layers in accordance with one or more embodiments of the present disclosure may be manufactured with a distinct marking differentiation (such as a distinct color or other marking) to differentiate the modified layers from the other tape layers that may comprise a reinforcement stack. The marking differentiation in accordance with one or more embodiments of the present disclosure may simplify the manufacturing process of making reinforcement stacks by preventing the modified tape layers from being used for other tapes in the stack other than the top and bottom layer. The marking differentiation may also simplify application of the formed reinforcement stacks to the pipe. It may be desirable for the modified tape used on the top of the reinforcement stack to be differentiated from the tape used on the bottom of the reinforcement stack, and, thus, the top and bottom tapes may have different markings. The marking differentiation may be incorporated into either or both the resin and the fiber components of the tape.

The modified tape layers, and the other tape layers of the reinforcement stacks, may be made by pultrusion. However, the modified tape layer may be made from a different die or set of dies (than those used for other tape layers) to form the radiused and/or additional thickness of the modified tape layers. In one or more embodiments the pultrusion process may be configured so that the fibers of the tape may be positioned such that one of the surfaces of the tape is resin rich, with the fibers distributed throughout the non-resin rich portion of the tape. Alternatively, the modified tape layers may be made through a process of co-pultrusion, where one of the other tape layers (i.e., those having a rectangular cross-section) may be pultruded a second time to add the additional layering (resin rich surface, anti-wear material, additional thickness, radiused corners, and/or any combinations thereof).

The modified layer(s) and the other tape layers may then be combined to form a reinforcement stack which may then be helically wound onto a pipe, as described in U.S. Pat. No. 6,804,942, issued on Oct. 19, 2004, entitled “Composite Tubular Assembly and Method of Forming Same,” incorporated herein by reference. For example, the reinforcement stacks may be helically wound onto a pipe to provide strength and/or support by providing tensile or hoop strength in an armor layer. Further, the lay angle of the reinforcement stack relative to the longitudinal axis of the pipe may be varied. For example, lower lay angles of the armor layer may provide greater tensile strength and higher lay angles of the armor layer may provide greater hoop strength and/or collapse resistance.

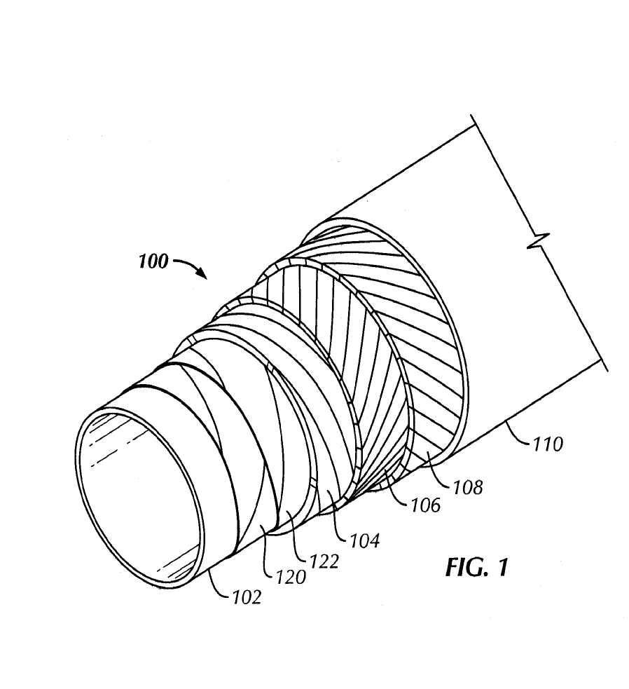

Referring to FIG. 1, an isometric view of a composite fiber reinforced flexible pipe 100 is shown. A fluid barrier (or liner or internal pressure sheath) 102 may be wrapped with a hoop reinforcement layer 104, tensile layers 106 and 108, and may be sealed, covered, and/or protected by a jacket (or outer sheath) 110. Further, an anti-extrusion layer may be included between the fluid barrier 102 and the hoop reinforcement layer 104. The anti-extrusion layer may include multiple layers and/or wrappings 120 and 122 of an anti-extrusion material, such as fiber reinforced tape, polymers, and/or any other pressure resistant material known in the art.

Hoop reinforcement layer 104 may be wound at any “lay angle” relative to the longitudinal axis of fluid barrier 102, in which higher lay angles may provide relatively high hoop strength and lower lay angles may provide relatively high axial strength. However, in accordance with one or more embodiments of the present disclosure, hoop reinforcement layer 104 may be wound at a relatively high lay angle relative to the longitudinal axis of the pipe, for example 60° to 89°, to provide internal pressure resistance against burst and/or external pressure resistance against collapse or crushing due to external loads.

An anti-abrasive (anti-wear) layer (not shown) may be disposed between the tensile layers 106 and 108, between the hoop reinforcement layer 104 and the tensile layer 106, and/or between any other layers of the pipe. Although FIG. 1 depicts a relatively simple composite pipe structure, those skilled in the art will appreciate that a composite flexible pipe may include additional and/or different layers, without departing from the scope of the present disclosure, including internal carcass, internal pressure sheath, hoop-stress reinforcement layers, anti-wear layers, lubricating layers, tensile reinforcement layers, anti-extrusion layers, membranes, and/or any other layers as may be included in a composite flexible fiber-reinforced pipe.

During manufacture of the composite flexible pipe 100, the reinforcement stacks that comprise armor layers (tensile and hoop) 104, 106, and 108 may be fed from dispensers and/or winders (not shown). Alternatively, tape layers may be fed from dispensers and/or winders (not shown), and then fed through a collector to form the reinforcement stacks of armor layers 14 and 16. Examples of dispensers and/or winders may be found in U.S. Pat. No. 6,491,779, issued on Dec. 12, 2002, entitled “Method of Forming a Composite Tubular Assembly,” U.S. Pat. No. 6,804,942, issued on Oct. 19, 2004, entitled “Composite Tubular Assembly and Method of Forming Same,” U.S. Pat. No. 7,254,933, issued on Aug. 14, 2007, entitled “Anti-collapse System and Method of Manufacture,” and U.S. Patent Application Publication 2009/0065630, filed on Sep. 11, 2007, entitled “Layered Tape Guide Spool and Alignment Device and Method,” all of which are hereby incorporated by reference herein in their entireties.

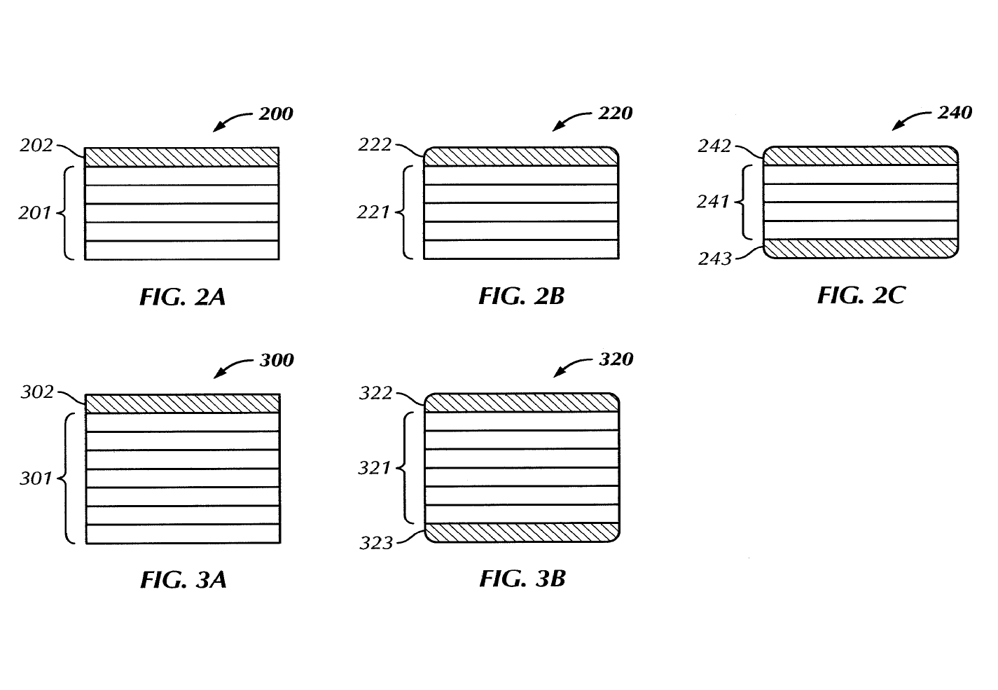

As discussed above, the reinforcement stacks may be composed of layers of tape bonded by an adhesive. Referring now to FIG. 2A, a cross-sectional view of a reinforcement stack 200, in accordance with one or more embodiments of the present disclosure, is shown. The reinforcement stack 200 may be composed of multiple tape layers 201. Further, a modified tape layer 202 may be installed at the top and/or bottom of the reinforcement stack 200, thereby forming a protective layer for the reinforcement stack 200.

As shown, the modified tape layer 202 is only installed on a top surface of the reinforcement stack 200. However, those skilled in the art will appreciate that the modified tape layer 202 may also be installed on a bottom surface of the reinforcement stack, without departing from the scope of the present disclosure. Further, a second modified tape layer (see FIG. 2C) may be installed on the opposite side of the reinforcement stack 200 (i.e., on the bottom surface) from the modified tape layer 202, thereby having a modified tape layer on both the top and bottom surfaces of the reinforcement stack 200.

The modified tape layer 202 may be similar to the tape layer 201, but may also include a resin rich surface. The resin rich surface may be applied to the surface of the modified tape layer 202 by a process of co-pultrusion. During manufacture of the tape layers 201, the fibers and matrix material may be pultruded to form a tape layer 201. One of the tape layers 201 may then be pultruded again (co-pultruded) in a process to add a resin rich surface to the tape layer, thereby forming a modified tape layer 202. Alternatively, the modified tape layer 202 may be formed separately from the tape layers 200 by an independent process, such as using different dies. The resin rich surface may provide additional thickness and/or strength to the tape layer such that fibers of the modified tape layer may not protrude from the surface of the modified tape layer. Additionally, the resin rich surface may be an anti-wear or anti-friction material, thereby providing additional properties to the reinforcement stack.

Now referring to FIG. 2B, a reinforcement stack 220 is shown. The reinforcement stack 220 comprises tape layers 221 and a modified tape layer 222. As shown in FIG. 2B, the modified tape layer 222 has radiused corners. In select embodiments, the corner radius of the modified tape layer 222 may be a radius greater than one-half the thickness of the modified tape layer 222, however, those skilled in the art will appreciate that any dimensioning of the radius may be used without departing from the scope of the present disclosure. Accordingly, an appropriately curved corner may be provided on the top and/or bottom surface of the reinforcement stack 220.

Now referring to FIG. 2C, a reinforcement stack 240 is shown. The reinforcement stack 240 may include tape layers 241 forming a body of the reinforcement stack 240, a first modified tape layer 242 may form a top layer of the reinforcement stack 240, and a second modified tape layer 243 may form a bottom layer of the reinforcement stack 240. As shown, the modified tape layers 242 and 243 may each include the resin rich component, as discussed with respect to FIG. 2A, and radiused corners, as discussed with respect to FIG. 2B.

In addition, as noted above, during manufacture of the modified tape layers, the modified tape layer may be constructed with a marking that is different than the remaining tape layers that may be used to form a reinforcement stack. Accordingly, if a modified tape layer is applied to a single surface (top or bottom) of a reinforcement stack, it may be known which side of the reinforcement stack contains the modified layer. As such, layers 202, 222, and 242 and 243 of FIGS. 2A, 2B, and 2C, respectively, may be marked such that they are distinguishable from the tape layers 201, 221, and 241 that comprise the body of the reinforcement stack.

Now referring to FIGS. 3A and 3B, embodiments of reinforcement stacks in accordance with the present disclosure are shown. FIG. 3A shows a cross-sectional view of a reinforcement stack 300 with a modified tape layer 302. FIG. 3B shows a cross-sectional view of a reinforcement stack 320 with modified tape layers 322 and 323.

The reinforcement stacks 300 and 320, as shown, are composed of a body of the reinforcement stack including tape layers 301 and 321, respectively. The modified tape layers 302 and 322 and 323, as shown, are configured to provide a top (and bottom) surface to the reinforcement stacks 300 and 320, respectively. Further, the modified tape layers 302, 322, and 323 are, as shown, modified such that additional thickness is provided to the tape layer. The additional thickness may be provided by a resin or other material, such as the matrix material that may be pultruded with the fibers in construction of the tape layers or any other materials as discussed above. As such, the modified tape layers with additional thickness may be co-pultruded, wherein the tape layer is pultruded once to form a tape layer of fibers and matrix material, and then pultruded a second time to add additional thickness with no fibers. Alternatively, the modified tape layers may be formed independently from the other tape layers using a different die or dies.

As shown in FIG. 3A, the modified tape layer 302 may have a rectangular cross-section but with additional thickness, similar to the tape layers 301. In contrast, as shown in FIG. 3B, the modified tape layers 322 and 323 may have radiused corners and may also include the additional thickness. Furthermore, as discussed above, the modified tape layers 302, 322, and 323 may be marking differentiated from the remaining tape layers of the reinforcement stacks, 301 and 321, respectively.

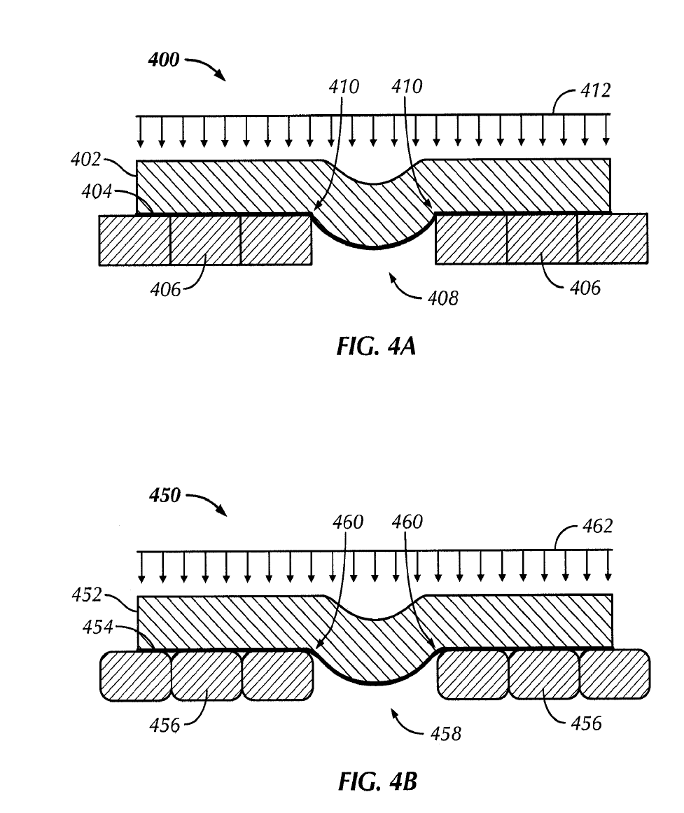

Now referring to FIGS. 4A and 4B, a partial cross-sectional view is shown of reinforcement stacks 406 and 456 installed on a pipe 400 and 450, respectively. As discussed above, reinforcement stacks in accordance with embodiments disclosed herein may provide enhanced gap control between adjacent windings of the reinforcement stacks 406 and 456, respectively. Embodiments disclosed herein may be employed with the gap control as disclosed in U.S. patent application Ser. No. 12/726,234, filed Mar. 17, 2010, entitled “Anti-Extrusion Layer with Non-Interlocked Gap Controlled Hoop Strength Layer,” all of which is hereby incorporated by reference in its entirety.

FIG. 4A shows pipe 400 with a gap 408 between adjacent windings of the reinforcement stacks 406. An anti-extrusion layer 404 may be disposed on a surface of the reinforcement stacks 406 and may be configured to prevent a liner 402 from blowing-out in the gap 408 between the reinforcement stacks due to pressure 412 applied to the liner 402. Rectangular (and/or sharp) corners 410 of the reinforcement stacks 406 may shear and/or tear the anti-extrusion layer 404, thereby reducing the effectiveness of the gap control layer.

Referring now to FIG. 4B, reinforcement stacks 456 may be installed on pipe 450 to provide reduced shearing. The corners 460 of reinforcement stacks 456 may be radiused, as discussed above, thereby preventing sharp corners from contacting, shearing, and/or tearing the anti-extrusion layer 454. Accordingly, when pressure 462 may be applied to the liner 452, the anti-extrusion layer 452 may not shear and blow-through gap 458.

Furthermore, in dynamic service, and in particular for reinforcement stacks that are performing the function of the pressure armor in dynamic service, the gap between adjacent reinforcement stacks may open and close in locations where the curvature varies with time due to dynamic motion. Thus, the portion of the anti-extrusion layer 454 that may be deformed into the gap 458 may change shape as the pipe curvature changes. If the anti-extrusion layer 454 conforms to the curved surface at locations 460 in FIG. 4B, rather than the sharp corners at location 410 in FIG. 4A, the fatigue loading on the anti-extrusion layer may be reduced, thus extending the life of the anti-extrusion layer 454 and, therefore, potentially extending the life of the flexible pipe structure.

Advantageously, reinforcement stacks in accordance with one or more embodiments of the present disclosure may provide increased efficiency in manufacturing of composite flexible pipe. Specifically, radiused corners of the reinforcement stacks may reduce friction and/or damage during manufacture, thereby increasing speeds of assembly and reducing down time of the process due to damage.

Additionally, reinforcement stacks in accordance with one or more embodiments of the present disclosure may provide simplicity in construction the reinforcement stacks. Specifically, marking differentiation of the modified top and/or bottom layer may simplify construction of the reinforcement stacks and increase efficiency during application of the reinforcement stacks disclosed herein.

Further, reinforcement stacks in accordance with one or more embodiments of the present disclosure may provide a resin rich (or material) layer on the surface of the reinforcement pipe. The resin rich layer may prevent fibers of the tape layers of the reinforcement stack from extending through the surface of the reinforcement stack and causing friction or damage to other layers of the flexible pipe to which the reinforcement layer is applied. For example, the resin rich layer (surface) may be in contact with an anti-wear layer and/or anti-extrusion layer. The resin rich layer may prevent fibers from extending from the reinforcement stack and contacting the anti-wear and/or anti-extrusion layer, thereby preventing damage and decreased life of the anti-wear and/or anti-extrusion layer.

Moreover, reinforcement stacks in accordance with one or more embodiments of the present disclosure may provide a surface (such as the resin rich layer) in which an anti-wear material may be incorporated. Accordingly, construction of a flexible pipe employing the reinforcement stacks disclosed herein may not need a separate anti-wear layer installed thereon. Therefore, layers of the flexible pipe may be eliminated without reducing the structural integrity of the pipe.

Furthermore, reinforcement stacks in accordance with one or more embodiments of the present disclosure may provide radiused corners to the reinforcement stacks. The radiused corners may prevent damage to an anti-extrusion layer when pressure is applied to a liner that may blow-through between gaps between reinforcement layers.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. An armor layer of an unbonded flexible pipe comprising:
a stack of reinforcement tapes wherein at least one of a top reinforcement tape and a bottom reinforcement tape of the stack comprises a resin rich surface.

2. The armor layer of claim 1, wherein the at least one of the top reinforcement tape and the bottom reinforcement tape comprises a radiused corner wherein the radiusing of the corner begins at a position along the vertical height of the reinforcement tape no more than one half the height of the reinforcement tape.

3. The armor layer of claim 1, wherein the at least one of the top reinforcement tape and the bottom reinforcement tape has a thickness greater than remaining reinforcement tapes in the tape stack.

4. The armor layer of claim 1, wherein the at least one of the top reinforcement tape and the bottom reinforcement tape has a marking different from the remaining reinforcement tapes in the tape stack.

5. The armor layer of claim 1, wherein the resin rich surface comprises an anti-wear material.

6. The armor layer of claim 1, wherein the resin rich surface comprises an anti-friction material.

7. The armor layer of claim 1, wherein the resin rich surface comprises at least one of polyphenylene sulfide, polyetheretherketone, polyvinylidene halide, vinyl halide polymer, vinyl halide copolymer, polyvinyl ketone, polyvinyl ether, polyvinyl methyl ether, polyvinyl aromatic, silicone, acrylic polymer, acrylic copolymer, polybutylmethacrylate, polyacrylonitrile, acrylonitrile-styrene copolymer, ethylene-methyl methacrylate copolymer, polyamide, polyimide, epoxy resin, polyurethane, polyoxymethylene, polysulfone, polyethersulfone, polyphenyl-sulfone, polyetherimide, polytetrafluoroethylene, perfluoropolyether, molybdenum disulfide, polyimide, liquid crystal polymers, polyphthalamide, cationic clay silicate, polyamide, polyureas, polyesters, polyacetals, polyethers, polyoxides, polysulfides, polysulphones, polyacrylates, polyethylene terephthalate, polyether-ether-ketones, polyvinyls, and polyacrylonitrils.

8. The armor layer of claim 1, wherein the at least one of the top reinforcement tape and the bottom reinforcement tape comprising the resin rich surface is formed by copultrusion.

9. A composite flexible pipe comprising at least one armor layer of claim 1.

10. The composite flexible pipe of claim 9, wherein the resin rich surface comprises an anti-wear layer of the flexible pipe.

11. An armor layer of an unbonded flexible pipe, comprising:
a stack of reinforcement tapes wherein at least one of a top reinforcement tape and a bottom reinforcement tape in the stack comprises a radiused corner wherein the radiusing of the corner begins at a position along the vertical height of the reinforcement tape no more than one half the height of the reinforcement tape.

12. The armor layer of claim 11, wherein the at least one of the top reinforcement tape and the bottom reinforcement tape further comprises a resin rich surface.

13. The armor layer of claim 1, wherein the at least one of the top reinforcement tape and the bottom reinforcement tape has a thickness greater than remaining reinforcement tapes in the tape stack.

14. The minor layer of claim 1, wherein the at least one of the top reinforcement tape and the bottom reinforcement tape has a marking different from remaining reinforcement tapes in the tape stack.

15. A method to manufacture an armor layer of an unbonded flexible pipe, comprising:
forming a plurality of reinforcement tapes through pultrusion;
forming a first modified reinforcement tape having a resin-rich surface through co-pultrusion; and
forming the armor layer by stacking the plurality of reinforcement tapes and the first modified reinforcement tape,
wherein the first modified reinforcement tape is disposed on one of a top surface and a bottom surface of the armor layer.

16. The method claim 15, further comprising:
forming a second modified reinforcement tape having a resin-rich surface through co-pultrusion,
wherein the second modified reinforcement tape is disposed on the other of the top surface and the bottom surface of the armor layer.

17. The method of claim 15, wherein the modified reinforcement tapes have a different marking than the plurality of reinforcement tapes.

18. A method to manufacture an armor layer of an unbonded flexible pipe, comprising:
forming a plurality of reinforcement tapes through pultrusion;
forming a first modified reinforcement tape having a radiused corner wherein the radiusing of the corner begins at a position along the vertical height of the first reinforcement tape no more than one half the height of the first reinforcement tape; and
forming the armor layer by stacking the plurality of reinforcement tapes and the first modified reinforcement tape,
wherein the first modified reinforcement tape is disposed on one of a top surface and a bottom surface of the armor layer.

19. The method claim 18, further comprising:
forming a second modified reinforcement tape having a radiused corner wherein the radiusing of the corner begins at a position along the vertical height of the second reinforcement tape no more than one half the height of the second reinforcement tape,
wherein the second modified reinforcement tape is disposed on the other of the top surface and the bottom surface of the armor layer.

20. The method of claim 18, wherein the modified reinforcement tapes have a different marking than the plurality of reinforcement tapes.
